(19) United States
(12) Patent Application Publication
(10) Pub. No.: US 2008/0238118 A1
(43) Pub. Date: Oct. 2, 2008

(54) THERMOFORM HUSH PANEL CLAMSHELL DESIGN

(75) Inventors: Stephen Halonen, Howell, MI (US); Michael Lorentz, Macomb, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/691,892

(22) Filed: Mar. 27, 2007

(51) Int. Cl. B62D 25/14

(52) U.S. Cl. 296/1.03

(57) ABSTRACT

A hush panel for integration into an automobile includes a first section having a first channel-forming portion and a second section having a second channel-forming portion. The first and second sections are attached together via a hinge section. The first and second sections pivotable relative to each other about the hinge section such that the first section mates to the second section with the first channel-forming portion and the second channel-forming portion aligning to form a duct in the hush panel. A method for forming the hush panel is also disclosed.

### BACKGROUND OF THE INVENTION

1. Field of the Invention

In at least one aspect, the present invention relates to thermoformed hush panel for incorporation into an automobile.

2. Background Art

Modern automobile designs continually strive to improve the aesthetic properties of automobile interiors. Such properties include the physical appearance of interior components. Noise perception is another perceived property which is desirably decreased. Moving parts in the engine compartment is one source of noise requiring attenuation.

Currently, strategies for reducing vehicle interior noise perception include incorporation of sound absorbing materials at various locations in the passenger cabin. For example, sound insulating materials are placed within door panels, over the cabin floor, within the instrument panel, and between the engine compartment and the vehicle interior. One such insulating component is a hush panel. Hush panels are typically placed at positions below the instrument panel between the engine firewall and the passenger cabin. Typically, the hush panel is made from a rigid plastic support structure overlaid with an acoustic sound absorbing layer or material. Air blower ducts are sometimes attached to the hush panel to move air from the blower to various locations in the passenger cabin. Such secondary attachment of air ducts undesirably adds extra processing steps and costs to the automobile manufacturing process.

Accordingly, there is a need for improved hush panels and methods for making such hush panels.

### SUMMARY OF THE INVENTION

The present invention solves one or more problems of the prior art by providing in at least one embodiment a hush panel for integration into an automobile. The hush panel of this embodiment comprises a first section having a first channel-forming portion and a second section having a second channel-forming portion. The first and second sections are attached together via a hinge section. The first and second sections pivot relative to each other about the hinge section such that the first section mates to the second section with the first channel-forming portion, and the second channel-forming portion aligning to form a duct in the hush panel. Advantageously, this integral duct concept eliminates several parts.

In another embodiment of the present invention, a method of forming the hush panel set forth above is provided. The method of this embodiment comprises introducing a resin sheet in a mold. The mold is then closed and heated at a sufficient temperature and pressure to form the hush panel. The hush panel is next removed. At this point the hush panel is in an opened state. Finally, prior to installation in an automobile interior, the hush panel is closed with one or more ducts being formed therein.

### BRIEF DESCRIPTION OF THE DRAWINGS

FIG. 1 is a perspective view of a vehicle interior that incorporates a variation of a hush panel;

FIG. 2 is a cross-sectional view showing the integration of a variation of a hush panel within a vehicle interior;

FIG. 3A is a cross-sectional view of a closed hush panel;

FIG. 3B is a cross-sectional view of an opened hush panel;

FIG. 4 is a top view of an opened hush panel;

FIG. 5 is a side view of a closed hush panel; and

FIG. 6 is a schematic flowchart illustrating an embodiment for forming a hush panel is provided.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

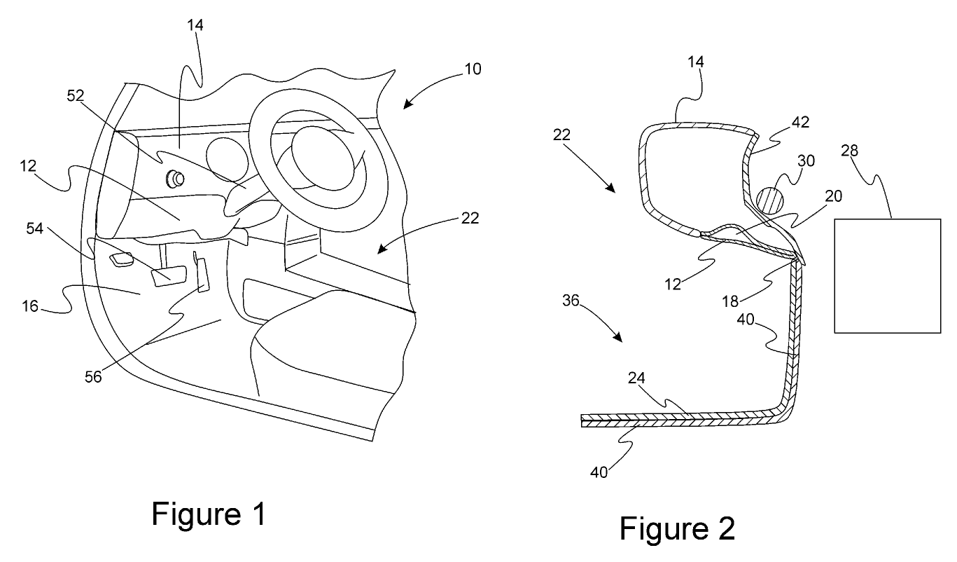

With reference to FIGS. 1 and 2, schematic illustrations of a vehicle assembly that includes an exemplary embodiment of a hush panel of the present invention is provided. FIG. 1 is a perspective view of a vehicle interior that incorporates the hush panel of this embodiment. FIG. 2 is a cross-sectional view showing the integration of the hush panel with the vehicle interior and vehicle frame components. Vehicle interior assembly 10 includes hush panel 12 and instrument panel 14. Hush panel 12 is located at a position below instrument panel 14. Vehicle floor 16 meets with hush panel 12 at position 18. In a variation of the present invention, hush panel 12 has duct 20 formed therein. As viewed from vehicle interior 22, vehicle floor 16 is covered with carpet 24. As set forth below, hush panel 12 provides sound insulation between vehicle interior 22 and vehicle engine 28 and blower 30. In another variation of the present invention, blower 30 is in communication with duct 30 allowing an air flow therein. Such an airflow is useful for heating or cooling vehicle interior 22 as required.

Still referring to FIGS. 1 and 2, vehicle floor section 36 includes vehicle frame section 40 which is covered by carpet 24. Typically, vehicle frame section 40 is formed from sheet metal. Vehicle frame section contacts firewall 42 at region 44. Firewall 42 provides a barrier between vehicle interior 22 and engine compartment 50. Automobile components such as steering column 52, brake pedal 54, and acceleration pedal 56 provide conduits for sound to enter into vehicle interior 22. Hush panel 12 prevents at least a portion of this sound from entering vehicle interior 22.

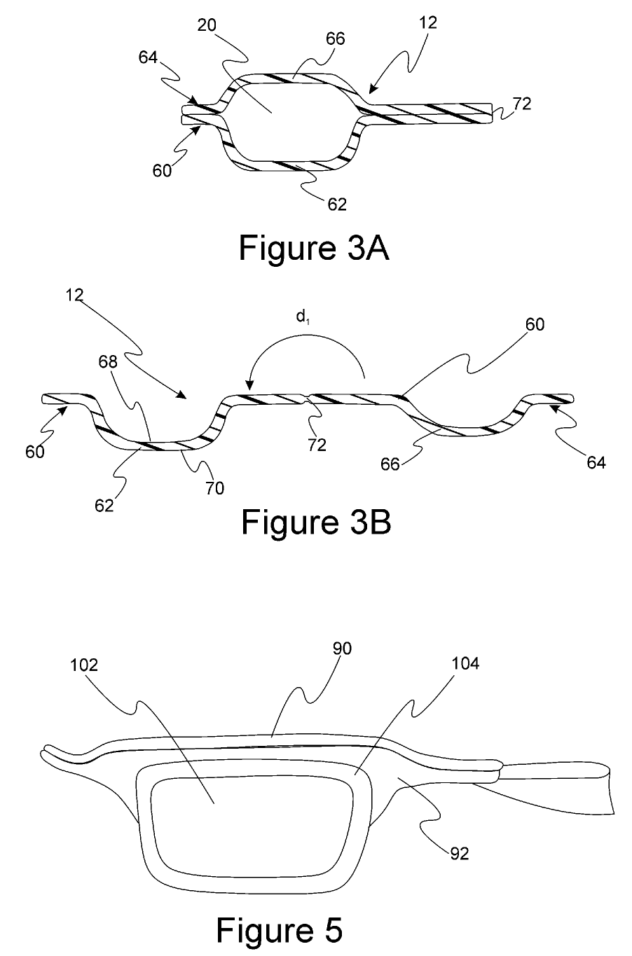

With reference to FIG. 3A, cross-sectional views showing the clam shell-like construction of a variation of hush panel 12 are provided. FIG. 3A is a cross-section of hush panel 12 in a closed state while FIG. 3B is a cross-sectional view of hush panel 12 in an open state. Hush panel 12 includes first section 60 which has first channel-forming portion 62. Hush panel 12 also includes second section 64 which has second channel-forming portion 66. Hinge section 72 is attached to first section 60 and second section 64. First section 60 and second section 64 are pivotable relative to each other about hinge section 72 along direction d₁ such that first section 60 mates to second section 64 with first channel-forming portion 64 and second channel-forming portion 66 aligning to form duct 20.

In a variation, one or both of first section 60 and second section 64 comprise a foamed resin. Examples of useful foamed resins include, but are not limited to, thermoplastic resins. Useful thermoplastic resins include polyolefin resins. A particularly useful foamed resin is polypropylene. Such polypropylene foams may be physically blown, non-crosslinked coploymer foam. Moreover, the foamed resin advantageously has a sufficient density to allow for efficient sound blocking when hush panel 12 is incorporated in a vehicle as set forth above in connection with the description of FIGS. 1 and 2. Typically, the foamed resin has a density from about 140 kg/m³ to about 180 kg/m³. In a refinement of this variation, the foamed resin has a density of about 160 kg/m³. If hush panel 12 is formed by a thermal processing technique such as thermoforming, these are the densities prior to processing. First section 60 and second section 64 have a sufficient combined thickness to attenuate sound incident upon hush panel 12. In a refinement of the present variation, the thickness of first section 60 is from about 2 to about 4 mm and the thickness of second section 64 is from about 2 to about 4 mm. The hush panel of the present embodiment provides improved sound rejection in the frequency range 50 Hz to 6300 Hz.

In one variation of the present embodiment, first section 60 and second section 64 are separate parts connected by hinge section 72. In another variation, first section 60 and second section 64 are contiguous and monolithic. In a refinement of this latter variation, first section 60, second section 64, and hinge section 72 comprise a foamed resin.

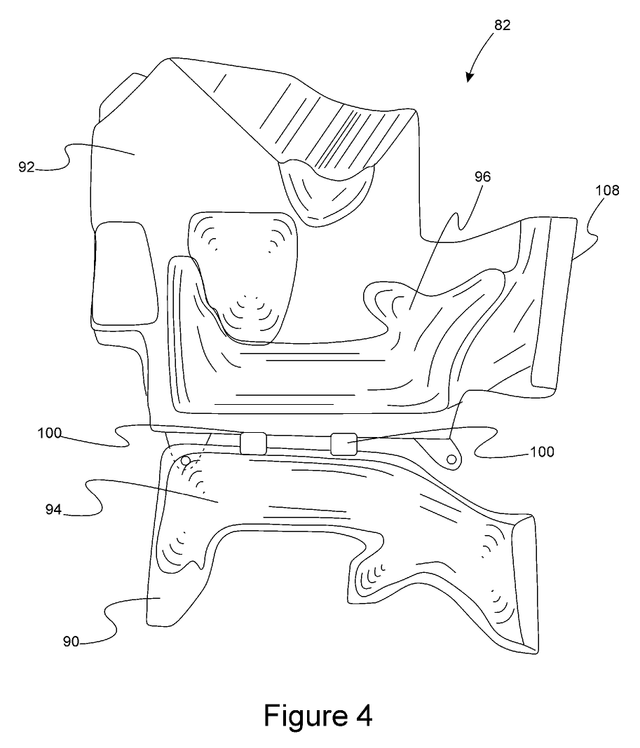

FIGS. 4 and 5 provide views of a variation of a hush panel formed by thermoforming. FIG. 4 is a top view of the opened hush panel. FIG. 5 is a side view of the closed hush panel. In this variation, hush panel 82 includes first section 90 and second section 92 as set forth above. First channel-forming portion 94 is thermoformed into first section 90 and second channel-forming portion 96 is thermoformed into second section 92. Hinge sections 100 are attached to first section 90 and second section 92. First section 90 and second section 92 are pivotable relative to each other about hinge sections 100 such that first section 90 mates to second section 92 with first channel-forming portion 94 and second channel-forming portion 96 aligning to form duct 102. Inlet 104 of duct 102 is formed within edge 108 of second section 92.

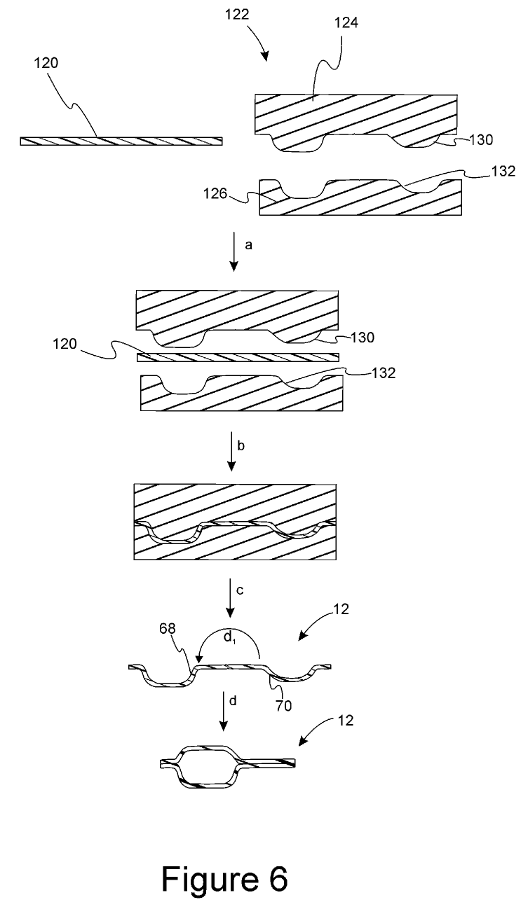

With reference to FIG. 6, a schematic flowchart illustrating an embodiment for forming a hush panel is provided. Hush panel 12 set forth above is formed by introducing resin sheet 120 into mold 122 in step a). Typically, mold 122 is a thermoforming mold. Mold 122 includes mold section 124, 126. Face 130 of mold section 124 is complementary to the side 68 of hush panel 12 while face 132 of mold section 126 is complementary to side 70 of hush panel 12. In step b), mold 122 is closed and heated at sufficient temperature and pressure to form hush panel 12. Hush panel 12 is removed in step c). At this point hush panel 12 is opened. Finally in step d), hush panel 12 is closed. The details of the composition and construction of the hush panel are the same as those set forth above. Specifically, the resin sheet comprises a thermoplastic resin such as polyolefins having a density from about 140 kg/m3 to about 180 kg/m3. Again, polypropylene is particularly useful.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A hush panel for integration into an automobile, the hush panel comprising:
a first section having a first channel-forming portion;
a second section having a second channel-forming portion; and
a hinge section attached to the first and second sections, the first and second sections being relatively pivotable about the hinge section such that the first section mates to the second section with the first channel-forming portion and the second channel-forming portion aligning to form a duct in the hush panel, wherein either the first section or the second section comprise a foamed resin.

2. The hush panel of claim 1 wherein the first and second sections each comprise a foamed resin.

3. The hush panel of claim 1 wherein the foamed resin comprises a thermoplastic resin.

4. The hush panel of claim 1 wherein the foamed resin comprises polypropylene.

5. The hush panel of claim 1 wherein the first section and second section are separate parts connected by the hinge section.

6. The hush panel of claim 1 wherein the first section, second section, and the hinge section are monolithic.

7. The hush panel of claim 6 wherein the first section, second section, and the hinge section comprise a foamed resin.

8. The hush panel of claim 6 wherein the first section, second section, and the hinge section comprise a foamed resin.

9. The hush panel of claim 8 wherein the foamed resin has a density from about 140 kg/m³ to about 180 kg/m³.

10. The hush panel of claim 8 wherein the first section and the second section have sufficient thickness to attenuate sound incident upon the hush panel.

11. The hush panel of claim 8 wherein the thickness of the first section is from about 2 to about 4 mm and the thickness of the second section is from about 2 to about 4 mm.

12. The hush panel of claim 10 wherein the duct is in communication with a blower.

13. A hush panel comprising a molded foam component, the molded foam component comprising:
a first section having a first channel-forming portion;
a second section having a second channel-forming portion; and
a hinge section attached to the first and second resin section, the first and second sections being pivotable about the hinge section such that the first section mates to the second section with the first channel-forming portion and the second channel-forming portion aligning to form a duct in the hush panel.

14. The hush panel of claim 13 wherein the molded foam component comprises a thermoplastic resin.

15. The hush panel of claim 14 wherein the molded foam component comprises polypropylene.

16. A method of forming a hush panel, the hush panel comprising:
a first section having a first channel-forming portion;
a second section having a second channel-forming portion; and
a hinge section attached to the first and second sections, the first and second sections being relatively pivotable about the hinge section such that the first section mates to the second section with the first channel-forming portion and the second channel-forming portion aligning to form a duct in the hush panel when the hush panel is closed, wherein the hush panel has a first hush panel surface and a second hush panel surface when the hush panel is open, the method comprising:
introducing a resin sheet into a mold, the mold having a first mold section and a second mold section, the first mold section having a first mold surface complementary to the first hush panel surface and the second mold section having a second mold surface complementary to the second hush panel surface;
closing the mold;
heating the mold to a sufficient temperature to form the hush panel; and
removing the hush panel from the mold.

17. The method of claim 16 further comprising closing the hush panel.

18. The method of claim 16 wherein the resin sheet comprises a thermoplastic resin.

19. The method of claim 16 wherein the resin sheet comprises a thermoplastic polypropylene.

20. The method of claim 16 wherein the resin sheet has a density from about 140 kg/m³ to about 180 kg/m³.
